(19) United States
(12) Patent Application Publication
(10) Pub. No.: US 2026/0313553 A1
(43) Pub. Date: Oct. 8, 2026

(54) WAKE-UP METHOD AND APPARATUS, COMMUNICATION DEVICE, AND STORAGE MEDIUM

(71) Applicant: Beijing Xiaomi Mobile Software Co., Ltd., Beijing (CN)

(72) Inventor: Yanhua LI, Beijing (CN)

(21) Appl. No.: 19/483,573

(22) PCT Filed: May 11, 2023
(86) PCT No.: PCT/CN2023/093686

§ 371 Date: Nov. 11, 2025

(51) Int. Cl. H04W 52/02; H04L 5/00

(52) U.S. Cl. CPC H04W 52/0235; H04L 5/0094; H04W 52/0219

(57) ABSTRACT

A method for waking up, performed by a network device, the method including: transmitting a low power wake-up signal (LP-WUS) in at least one initial bandwidth part (BWP), where the LP-WUS is configured to wake up a second transceiver of at least one type of terminal after being monitored by a first transceiver of the terminal.

### CROSS-REFERENCE TO RELATED APPLICATION

The present application is a U.S. National Stage of International Application No. PCT/CN2023/093686, filed on May 11, 2023, the contents of all of which are incorporated herein by reference in their entirety for all purposes.

### BACKGROUND OF THE INVENTION

In the field of wireless communication technologies, detection of a wake-up signal is needed for a terminal in a non-connected state. In some scenarios, it is desired to introduce an independent transceiver (ultra-low power wake-up receiver) to receive the wake-up signal.

### SUMMARY OF THE INVENTION

The present disclosure relates to, but is not limited to, the field of wireless communication technologies, and in particular, to a method and device for waking up, a communication device, and a storage medium.

A first aspect of the embodiments of the present disclosure provides a method for waking up, performed by a network device, including:
transmitting a low power wake-up signal (LP-WUS) in at least one initial bandwidth part (BWP), where the LP-WUS is configured to wake up a second transceiver of at least one type of terminal after being monitored by a first transceiver of the terminal.

A second aspect of the embodiments of the present disclosure provides a method for waking up, performed by a terminal, including:
receiving an LP-WUS transmitted in at least one initial BWP, where the LP-WUS is configured to wake up a second transceiver of at least one type of terminal after being monitored by a first transceiver of the terminal.

A third aspect of the embodiments of the present disclosure provides a device for waking up, including:
a transmitting module, configured to transmit an LP-WUS in at least one initial BWP, where the LP-WUS is configured to wake up a second transceiver of at least one type of terminal after being monitored by a first transceiver of the terminal.

A fourth aspect of the embodiments of the present disclosure provides a device for waking up, including:
a receiving module, configured to receive an LP-WUS transmitted in at least one initial BWP, where the LP-WUS is configured to wake up a second transceiver of at least one type of terminal after being monitored by a first transceiver of the terminal.

A fifth aspect of the embodiments of the present disclosure provides a communication device, including one or more processors, a transceiver, a memory and an executable program stored on the memory and executable by the one or more processors, where the executable program, when executed by the one or more processors, causes the communication device to perform the method for waking up provided in the first aspect or the second aspect.

A sixth aspect of the embodiments of the present disclosure provides a non-transitory computer-readable storage medium which stores an executable program, where the executable program, when executed by one or more processors of a communication device, causes the communication device to perform the method for waking up provided in the first aspect or the second aspect.

### BRIEF DESCRIPTION OF DRAWINGS

The accompanying drawings in the present disclosure are incorporated into the specification and constitute a part of the specification, showing the principles consistent with embodiments of the present disclosure and used together with the specification to explain the embodiments of the present disclosure.

FIG. 1 is a schematic architectural diagram of a wireless communication system according to an example.

FIG. 2 is a schematic flowchart of a method for waking up according to an example.

FIG. 3 is a schematic flowchart of a method for waking up according to an example.

FIG. 4 is a schematic flowchart of a method for waking up according to an example.

FIG. 5 is a schematic flowchart of a method for waking up according to an example.

FIG. 6 is a schematic structural diagram of a device for waking up according to an example.

FIG. 7 is a schematic structural diagram of a device for waking up according to an example.

FIG. 8 is a schematic structural diagram of a terminal according to an example.

FIG. 9 is a schematic structural diagram of a communication device according to an example.

### DETAILED DESCRIPTION OF THE INVENTION

Examples will be described in detail in the present disclosure, and instances of the examples are indicated in the accompanying drawings. When the following descriptions involve the accompanying drawings, unless otherwise indicated, the same numbers in different accompanying drawings indicate the same or similar elements. The implementations described in the following examples do not represent all implementations consistent with the embodiments of the present disclosure. Rather, they are merely instances of devices and methods consistent with some aspects of the embodiments of the present disclosure.

The terms used in the embodiments of the present disclosure are merely for the purpose of describing specific embodiments, and are not intended to limit the embodiments of the present disclosure. The singular expressions such as “a,” “an,” “the,” “the above-mentioned,” “the aforementioned,” and “this” in the embodiments of the present disclosure also include plural expressions, unless the context clearly indicates the contrary. It is also to be understood that the term “and/or” used in the present disclosure refers to and contains any or all possible combinations of one or more associated listed items. In the embodiments of the present disclosure, “a plurality of” refers to two or more. In the embodiments of the present disclosure, prefixes such as “first” and “second” are merely used to distinguish different described objects, and do not impose restrictions on the position, order, priority, quantity, content, or other aspects of the described objects. The statements about the described objects refer to the descriptions in the context of the claims or the embodiments, and no redundant restrictions shall be constituted due to the use of numerical prefixes. For example, the terms like “first,” “second,” and “third” are used to describe various types of information, but such information shall not be limited to these terms. These terms are merely used to distinguish the same type of information from each other. For example, without departing from the scope of the embodiments of the present disclosure, first information may also be referred to as second information, and similarly, the second information may also be referred to as the first information. Depending on the context, the word “if” as used in the present disclosure may be interpreted as “at the time,” “when,” or “in response to determining.” In some embodiments, the names of information and the like are not limited to those recorded in the embodiments, and the terms such as “information,” “message,” “signaling,” “report,” “indication,” “configuration,” and “data” may be used interchangeably.

In some embodiments of the present disclosure, “acquire,” “obtain,” “get,” “receive,” and “transmit (send and/or receive)” are interchangeable, which may be interpreted as various meanings such as receiving from other subjects, obtaining from protocols, and obtaining through self-processing.

In some embodiments of the present disclosure, “send,” “report,” “issue,” and “transmit (send and/or receive)” may be used interchangeably.

In the field of wireless communication technologies, detection of a wake-up signal is needed for a terminal in a non-connected state. In some scenarios, it is desired to introduce an independent transceiver (ultra-low power wake-up receiver) to receive the wake-up signal. However, there is still no solution for an operating state of the terminal after introducing the independent transceiver in user equipment (UE).

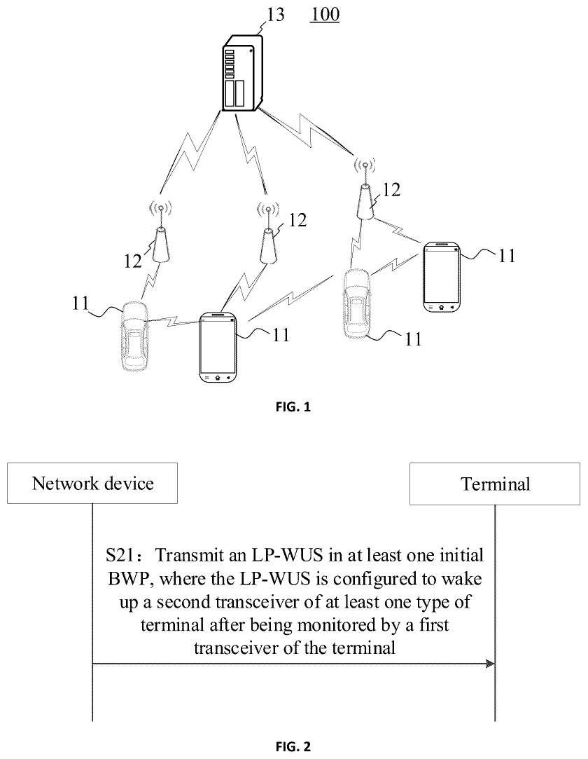

Referring to FIG. 1, it shows a schematic architectural diagram of a wireless communication system 100 provided by an embodiment of the present disclosure. As shown in FIG. 1, the wireless communication system 100 is a communication system based on a cellular mobile communication technology. The wireless communication system 100 may include a plurality of UEs 11 and a plurality of access network elements 12.

The UE 11 may refer to devices that provide a user with at least one of speech or data connectivity. The UE 11 may communicate with one or more core networks via a radio access network (RAN). The UE 11 may be Internet-of-things UEs, such as sensor devices, mobile phones (or called “cellular” phones), and computers with Internet-of-things UEs. For example, the UE may be fixed, portable, pocket-sized, handheld, computer-built-in, or vehicle-mounted devices. For example, the UE may be stations (STAs), subscriber units, subscriber stations, mobile stations, mobiles, remote stations, access points, remote terminals, access terminals, user terminals, user agents, or user equipment (UEs). Alternatively, the UE 11 may also be unmanned aircraft devices. Alternatively, the UE 11 may also be vehicle-mounted devices, such as a trip computer with a wireless communication function, or a wireless communication device connected with an external trip computer. Alternatively, the UE 11 may also be roadside devices, such as a street lamp, a signal light, or other roadside devices with wireless communication functions.

The access network elements 12 may be network devices in the wireless communication system. The wireless communication system may be the 4th generation mobile communication (4G) system, also called a long term evolution (LTE) system; or, the wireless communication system may also be a 5G system, also called a new radio (NR) system or a 5G NR system. Alternatively, the wireless communication system may also be a next-generation system of the 5G system. An access network in the 5G system may be referred to as a new generation-radio access network (NG-RAN). Alternatively, it is an MTC system.

The access network elements 12 may be evolved access devices (eNBs) adopted in the 4G system. Alternatively, the access network elements 12 may also be access devices (gNBs) adopting centralized and distributed architectures in the 5G system. In a case where the access network elements 12 adopt the centralized and distributed architectures, they typically each include a central unit (CU) and at least two distributed units (DUs). Protocol stacks of a packet data convergence protocol (PDCP) layer, a radio link control (RLC) layer, and a media access control (MAC) layer are disposed in the central unit. Further, protocol stacks of physical (PHY) layers are disposed in the distributed units. Specific implementations of the access network elements 12 are not limited to the embodiments of the present disclosure.

The access network elements 12 and the UE 11 may establish wireless connections through wireless radio. In different implementations, the wireless radio is wireless radio based on the 4G standard; or, the wireless radio is wireless radio based on the 5G standard, such as new radio; or, the wireless radio may also be wireless radio based on the next-generation mobile communication standard of 5G.

In some embodiments, the wireless communication system may further contain a core network element 13.

The plurality of access network elements 12 are connected with the core network element 13. The core network element 13 may be a core network device in the wireless communication system, for example, the core network element 13 may be a mobility management entity (MME) in an evolved packet core (EPC). Alternatively, the core network device may also be other core network devices, such as a serving gateway (SGW), a public data network gateway (PGW), a policy and charging rules function (PCRF), or a home subscriber server (HSS), etc. Alternatively, the core network element 13 may also be a core network device in 5G; for example, it may be a policy control function (PCF), a session management function (SMF), an access and mobility management function (AMF), unified data management (UDM), or a user plane function (UPF), etc. The implementation form of the core network element 13 is not limited to the embodiments of the present disclosure.

In some embodiments, a power-saving signal is introduced for a UE in a connected state. The power-saving signal may be a wakeup signal or downlink control information for power saving (DCP). For example, in a case where the UE detects the wakeup signal, it determines that it needs to monitor a physical downlink control channel (PDCCH); and in a case where the UE does not detect the wakeup signal, it skips the PDCCH monitoring.

In some embodiments, a power-saving signal is introduced for a UE in an idle state. The power-saving signal may serve as a paging early indication (PEI). The PEI may be configured before a paging occasion (PO). For example, in a case where the UE detects the power-saving signal, it needs to monitor paging downlink control information (DCI); and in a case where the UE does not detect the power-saving signal, it skips the paging DCI monitoring.

In some embodiments, enhancements are made for the UE in the connected state, and a physical downlink control channel (PDCCH) skipping mechanism is introduced. For example, in a case where the UE detects DCI carrying information indicating the PDCCH skipping mechanism, it determines to skip monitoring for a predetermined period of time or determines to perform search space group switching.

In some embodiments, regardless of the type of power-saving signal, a terminal's modem needs to detect the power-saving signal at this time. However, it is desirable to introduce an independent transceiver to receive the power-saving signal, and the modem part or a main radio part of the terminal may only be woken up after the independent transceiver is woken up, otherwise, the modem part will remain in a sleep state.

In some embodiments, a network introduces two initial bandwidth parts (BWPs), namely an initial BWP used by normal users and an initial BWP used by reduced capability (Redcap) users. In this case, there is no conclusion on which initial BWP an LP-WUS is transmitted in.

An embodiment of the present disclosure provides a method for waking up, performed by a network device, including: transmitting an LP-WUS in at least one initial BWP, where the LP-WUS is configured to wake up at least one type of terminal. In some examples, waking up the at least one type of terminal includes: waking up a second transceiver of the at least one type of terminal.

As shown in FIG. 2, an embodiment of the present disclosure provides a method for waking up, performed by a network device, including the following step S21.

In step S21, an LP-WUS is transmitted in at least one initial BWP, where the LP-WUS is configured to wake up a second transceiver of at least one type of terminal after being monitored by a first transceiver of the terminal.

In some embodiments, transmitting the LP-WUS in the at least one initial BWP includes: transmitting the LP-WUS to at least one terminal in the at least one initial BWP; or transmitting the LP-WUS to the at least one type of terminal in the at least one initial BWP.

In some examples, the network device may be other functions or nodes which are flexibly deployed in an access network. In some examples, the network device may be various types of base stations. For example, the base stations may be at least one of the following: a 2G base station, a 3G base station, a 4G base station, a 5G base station, or other evolved base stations.

In some examples, the terminal may be, but is not limited to, the UE in the embodiments. In some examples, the terminal may be at least one of the following: a mobile phone, a computer, a server, a wearable device, a game control platform, a roadside device, a vehicle-mounted device, or a multimedia device. In some examples, the terminal may be at least one of the following: a reduced capability UE, a 5G energy-saving (NR-lite) terminal, a reduced capability (Redcap) terminal, or an enhanced reduced capability (eRedcap) terminal.

In some examples, the terminal may be a terminal in a non-connected state. The terminal in the non-connected state includes at least one of a terminal in an idle state or a terminal in an inactive state. For example, the terminal in the idle state is a radio resource control (RRC) terminal in the idle state. For example, the terminal in the inactive state is an RRC terminal in the inactive state.

In some examples, the at least one type of terminal includes a first type of terminal and a second type of terminal.

For example, the first type of terminal may be a normal terminal or any terminal. For instance, the first type of terminal is an enhanced mobile broadband (eMBB) terminal. And/or, the second type of terminal may be at least one of a Redcap terminal or an eRedcap terminal.

For example, the first type of terminal has a higher power consumption than the second type of terminal.

For example, a limited range of at least one of time domain resources or frequency domain resources scheduled from the first type of terminal is larger than a limited range of at least one of time domain resources or frequency domain resources scheduled from the second type of terminal. Alternatively, a limited degree of at least one of time domain resources or frequency domain resources scheduled from the first type of terminal is higher than a limited degree of at least one of time domain resources or frequency domain resources scheduled from the second type of terminal.

In some embodiments, waking up the terminal may include: waking up the second transceiver of the terminal. For example, the terminal includes the first transceiver and the second transceiver. After the first transceiver is woken up, the terminal monitors the LP-WUS through the first transceiver, and in a case where the LP-WUS is monitored, the second transceiver is woken up.

In some examples, the power consumption of the first transceiver is less than that of the second transceiver. The power consumption of the first transceiver being less than that of the second transceiver may include: power consumed by receiving information and/or transmitting information by the first transceiver being less than power consumed by receiving information and/or transmitting information by the second transceiver. For example, the first transceiver consumes less power for decoding each signal than the second transceiver decoding the same signal.

In some examples, the structure of the first transceiver is simpler than that of the second transceiver. For example, the second transceiver may be a main radio of the terminal; and the first transceiver is an independent transceiver (ultra-low power wake-up receiver) introduced by the terminal.

In some examples, the first transceiver has receiving and transmitting functions, and the second transceiver has receiving and transmitting functions.

In some examples, the first transceiver may also be a first receiver; and/or, the second transceiver may be a second receiver. The first receiver has a receiving function, and/or, the second receiver has a receiving function.

In some examples, the first transceiver is an auxiliary radio, and the second transceiver is the main radio. The auxiliary radio is configured to assist the main radio in receiving information and/or transmitting information.

In some embodiments, one initial BWP includes at least one of a first initial BWP or a second initial BWP.

In some examples, the first initial BWP may be an initial BWP configured by the network device. For example, the network device configures the first initial BWP through a system message. In some examples, the network device configures the first initial BWP through a master information block (MIB) or a system message block (SIB) X, where X is an integer greater than 0. In some examples, the first initial BWP may include at least one of a first control resource set (Coreset0or a synchronization signal block (SSB).

In some examples, the second initial BWP may also be an initial BWP configured by the network device. In some examples, the second initial BWP may include at least one of the first control resource set (Coreset0) or the SSB.

In some examples, the first initial BWP is different from the second initial BWP.

In some embodiments, the initial BWP is a downlink initial BWP. In some examples, the first initial BWP is a first downlink initial BWP, and/or the second initial BWP is a second downlink initial BWP.

In the embodiment of the present disclosure, the network device transmits the LP-WUS in the at least one initial BWP, where the LP-WUS is configured to wake up the second transceiver of the at least one type of terminal after being monitored by the first transceiver of the terminal. Thus, the second transceiver with relatively high power consumption is woken up only after the first transceiver with relatively low power consumption monitors the LP-WUS, so that the power consumption of the terminal may be lowered. Further, one or more types of terminals may be woken up by transmitting the LP-WUS in the at least one initial BWP, so that a specific manner of waking up the terminal is provided.

It is to be noted that, those skilled in the art may understand that the method provided by the embodiment of the present disclosure may be performed separately, or performed with some methods in the embodiment of the present disclosure or some methods in the related art.

In some embodiments, transmitting the LP-WUS in the at least one initial BWP includes: transmitting different LP-WUSs in different initial BWPs, where the different LP-WUSs transmitted in the different initial BWPs are configured to wake up different types of terminals.

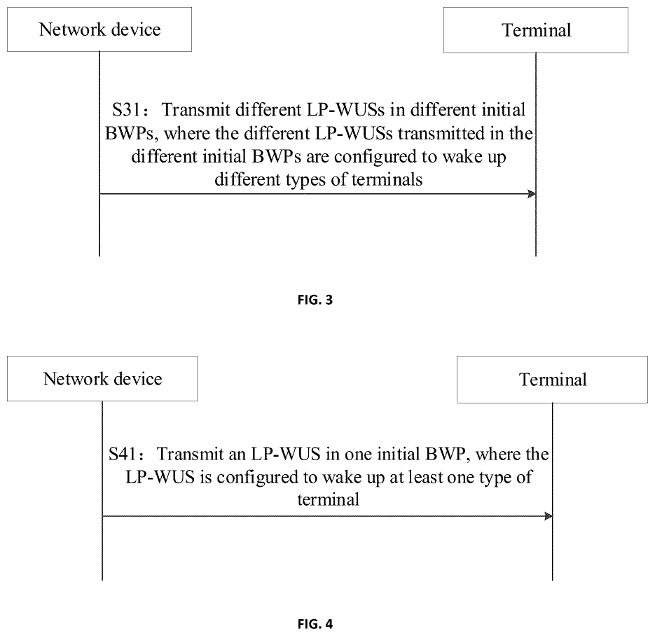

As shown in FIG. 3, an embodiment of the present disclosure provides a method for waking up, performed by a network device, including the following step S31.

In step S31, different LP-WUSs are transmitted in different initial BWPs, where the different LP-WUSs transmitted in the different initial BWPs are configured to wake up different types of terminals.

In some embodiments of the present disclosure, the initial BWP may be the initial BWP in the above embodiment, the LP-WUS may be the LP-WUS in the above embodiment, and the terminal may be the terminal in the above embodiment.

In some examples, the initial BWP includes at least one of a first initial BWP or a second initial BWP.

In some examples, the LP-WUS includes at least one of a first LP-WUS or a second LP-WUS. In some examples, the first LP-WUS is configured to wake up a first type of terminal, and/or the second LP-WUS is configured to wake up a second type of terminal.

In some examples, the terminal includes at least one of the first type of terminal or the second type of terminal.

In some embodiments, transmitting the different LP-WUSs in the different initial BWPs includes at least one of the following:
transmitting first configuration information including the first LP-WUS in the first initial BWP, where the first LP-WUS transmitted in the first initial BWP is configured to wake up the first type of terminal; or
transmitting second configuration information including the second LP-WUS in the second initial BWP, where the second LP-WUS transmitted in the second initial BWP is configured to wake up the second type of terminal.

The embodiment of the present disclosure provides a method for waking up, performed by a network device, including at least one of the following:
transmitting the first configuration information including the first LP-WUS in the first initial BWP, where the first LP-WUS transmitted in the first initial BWP is configured to wake up the first type of terminal; or
transmitting the second configuration information including the second LP-WUS in the second initial BWP, where the second LP-WUS transmitted in the second initial BWP is configured to wake up the second type of terminal.

In some embodiments, both the first LP-WUS and the second LP-WUS may be indicated by one or more bits.

In some examples, the first LP-WUS is different from the second LP-WUS. For example, the first LP-WUS is “0” or “00,” and the second LP-WUS is “1” or “11.”

In some examples, the first LP-WUS is the same as the second LP-WUS. For example, both the first LP-WUS and the second LP-WUS may be “0,” or “11,” etc. As the first LP-WUS and the second LP-WUS are transmitted by being carried in the different initial BWPs, therefore, wakeup of the different types of terminals may be indicated even though the first LP-WUS is the same as the second LP-WUS.

In some examples, transmitting the first configuration information including the first LP-WUS in the first initial BWP may include: transmitting the first LP-WUS in the first initial BWP; or, transmitting the first configuration information in the first initial BWP, where the first configuration information includes the first LP-WUS.

In some examples, transmitting the second configuration information including the second LP-WUS in the second initial BWP may include: transmitting the second LP-WUS in the second initial BWP; or, transmitting the second configuration information in the second initial BWP, where the second configuration information includes the second LP-WUS.

In some embodiments, the initial BWP includes at least one of a first control resource set (Coreset0) or an SSB.

In some examples, the first initial BWP includes at least one of the first control resource set (Coreset0) or the SSB. For example, the first initial BWP includes at least one of the Coreset0 or the SSB, and the first LP-WUS or the first configuration information is transmitted in the first initial BWP, which is configured to wake up the first type of terminal. Alternatively, the first initial BWP includes at least one of the Coreset0 or the SSB, but the first initial BWP does not carry the first LP-WUS, which is not configured to wake up the first type of terminal.

In some examples, the second initial BWP includes at least one of the first control resource set (Coreset0) or the SSB. For example, the second initial BWP includes at least one of the Coreset0 or the SSB, and the second LP-WUS or the second configuration information is transmitted in the second initial BWP, which is configured to wake up the second type of terminal. Alternatively, the second initial BWP includes at least one of the Coreset0 or the SSB, but the second initial BWP does not carry the second LP-WUS, which is not configured to wake up the second type of terminal.

In some examples, the first configuration information includes at least one of time domain information or frequency domain information of the monitored first LP-WUS. For example, the at least one of time domain information or frequency domain information is configured to indicate at least one of time domain resource or frequency domain resource for transmitting the first LP-WUS. As such, the terminal may be enabled to know on which at least one of time domain resource or frequency domain resource the first LP-WUS is monitored, so that the success rate of monitoring is increased.

In some examples, the second configuration information includes time domain information of the monitored second LP-WUS. For example, the time domain information is configured to indicate the second LP-WUS. For example, the time domain information includes at least one of the following: a duty cycle or a configuration reference time point.

In some examples, the configuration reference time point may include at least one of the following: an offset value of a PO, or an offset value of a PEI. For example, the offset value of the PO is configured to indicate an offset of a time domain resource where the second LP-WUS is located relative to the PO. For example, the offset value of the PEI is configured to indicate an offset of the time domain resource where the second LP-WUS is located relative to the PEI. In other embodiments, the configuration reference time point may further be an offset of the time domain resource where the second LP-WUS is located relative to any information such as at least one of a paging message or the PEI.

As the second configuration information includes the time domain information of the second LP-WUS, the second configuration information is applicable to being shared by a plurality of initial BWPs. As such, the terminal may be enabled to know on which time domain resource the second LP-WUS is monitored, and the terminal may be enabled to monitor the first LP-WUS in at least the initial BWPs.

In the embodiment of the present disclosure, the different initial BWPs may be configured to carry the different LP-WUSs or the same LP-WUS, so as to be configured to indicate wakeup of the different types of terminals. Thus, the different types of terminals may be woken up.

In some embodiments, the LP-WUS is configured to wake up one of the following:
all terminals monitoring the LP-WUS, or at least part of the terminals monitoring the LP-WUS; or

a specified terminal, where the specified terminal includes at least one of the following: at least one group of terminals grouped based on the PEI, or at least one group of terminals grouped based on the PO.

In some examples, the specified terminal may be a terminal grouped according to a preset grouping rule. The preset grouping rule may be any grouping rule. For example, the preset grouping rule may include a rule of grouping based on indexes or serial numbers of terminals, a rule of grouping based on operators to which terminals belong, or the like, which is not limited to the present disclosure.

In some examples, the at least one group of terminals grouped based on the PEI is at least one specified group of terminals. For example, a plurality of groups may be obtained by grouping based on the PEI, and the at least one specified group of terminals is indicated through at least one of different values of at least one bit in the LP-WUS or different at least one bit in the LP-WUS. For example, the first bit in the LP-WUS is “1,” which is configured to wake up a first group of terminals in the PEI groups, or, the first bit in the LP-WUS is “0,” which is not configured to wake up the first group of terminals in the PEI groups; and/or, the second bit in the LP-WUS is “1,” which is configured to wake up a second group of terminals in the PEI groups, or, the second bit in the LP-WUS is “0,” which is not configured to wake up the second group of terminals in the PEI groups.

In some examples, the at least one group of terminals grouped based on the PO is at least one specified group of terminals. For example, a plurality of groups may be obtained by grouping based on the PO, and the at least one specified group of terminals is indicated through at least one of different values of at least one bit in the LP-WUS or different at least one bit in the LP-WUS. For example, the first bit in the LP-WUS is “1,” which is configured to wake up a first group of terminals in the PO groups, or, the first bit in the LP-WUS is “0,” which is not configured to wake up the first group of terminals in the PO groups; and/or, the second bit in the LP-WUS is “1,” which is configured to wake up a second group of terminals in the PO groups, or, the second bit in the LP-WUS is “0,” which is not configured to wake up the second group of terminals in the PO groups.

In some examples, the LP-WUS is the first LP-WUS, and the first LP-WUS is configured to wake up one of the following: all first type of terminals monitoring the first LP-WUS, at least part of the first type of terminals monitoring the first LP-WUS, or a specified first type of terminal.

In some examples, the LP-WUS is the second LP-WUS, and the second LP-WUS is configured to wake up one of the following: all second type of terminals monitoring the second LP-WUS, at least part of the second type of terminals monitoring the second LP-WUS, or a specified second type of terminal.

As such, the LP-WUS may be configured to wake up all or part of terminals in the different types of terminals or at least one group of terminals obtained according to a certain grouping rule (grouping based on the PEI or grouping based on the PO), so that these terminals are woken up at low power consumption, and the power consumption of these terminals is saved.

In some embodiments, a search space for at least one of the paging message or the PEI is configured based on the initial BWP, but the initial BWP does not include the LP-WUS or does not include configuration of the LP-WUS (e.g., the first configuration information or the second configuration information). The initial BWP is configured by the terminal to monitor at least one of the paging message or the PEI according to a paging mechanism. In some examples, the initial BWP includes at least one of the first initial BWP or the second initial BWP. The LP-WUS includes at least one of the first LP-WUS or the second LP-WUS.

As such, in the embodiment of the present disclosure, in a case where the network device does not configure the LP-WUS on the initial BWP, the initial BWP may make the terminal perform paging according to a traditional paging mechanism, and thus the terminal may be woken up.

It is to be noted that, those skilled in the art may understand that the method provided by the embodiment of the present disclosure may be performed separately, or performed with some methods in the embodiment of the present disclosure or some methods in the related art.

In some embodiments, transmitting the LP-WUS in the at least one initial BWP includes: transmitting the LP-WUS in one initial BWP, where the LP-WUS is configured to wake up at least one type of terminal.

As shown in FIG. 4, an embodiment of the present disclosure provides a method for waking up, performed by a network device, including the following step S41.

In step S41, an LP-WUS is transmitted in one initial BWP, where the LP-WUS is configured to wake up at least one type of terminal.

In some embodiments of the present disclosure, the initial BWP may be the initial BWP in the above embodiment, the LP-WUS may be the LP-WUS in the above embodiment, and the terminal may be the terminal in the above embodiment.

In some examples, the initial BWP includes a first initial BWP. The LP-WUS includes a first LP-WUS.

In some examples, the first LP-WUS may be configured to wake up at least one type of terminal, or wake up all types of terminals. For example, the first LP-WUS is configured to wake up a first type of terminal, and the first LP-WUS may further be configured to wake up a second type of terminal.

In some embodiments, transmitting the LP-WUS in the one initial BWP includes: transmitting first configuration information including the first LP-WUS in one initial BWP, where the first LP-WUS is configured to wake up a plurality of types of terminals.

The embodiment of the present disclosure provides a method for waking up, performed by a network device, including: transmitting the first configuration information including the first LP-WUS in the one initial BWP, where the first LP-WUS is configured to wake up a plurality of types of terminals.

In the embodiment of the present disclosure, the same initial BWP may be configured to carry the LP-WUS, so as to wake up one or more types of terminals.

In some embodiments, transmitting the first configuration information including the first LP-WUS in the one initial BWP includes: transmitting, based on a fact that a second initial BWP does not include at least one of a first control resource set (Coreset0) or an SSB, the first configuration information including the first LP-WUS in the first initial BWP, where the first LP-WUS transmitted in the first initial BWP is further configured to wake up the second type of terminal. The first LP-WUS may further be configured to wake up the first type of terminal.

In some examples, the first configuration information may be the first configuration information in the above embodiment.

In some examples, the network device transmits the first configuration information in the first initial BWP, the first configuration information includes the first LP-WUS, and the first LP-WUS is configured to wake up the first type of terminal and the second type of terminal. In the present disclosure, the first type of terminal monitors the first LP-WUS transmitted in the first initial BWP, and determines to wake up a second transceiver. The second type of terminal monitors the second initial BWP, and determines that the second initial BWP does not include a second LP-WUS, or the second type of terminal determines that the second initial BWP does not include at least one of Coreset0 or an SSB (i.e., the second type of terminal cannot determine that the second LP-WUS is not configured in the second initial BWP). At this time, the second type of terminal needs to monitor the first initial BWP, and the second type of terminal determines to wake up the second transceiver in a case of determining that the first initial BWP includes the first LP-WUS.

As such, the plurality of types of terminals may be monitored by configuring the LP-WUS in one initial BWP.

In some embodiments, the first LP-WUS includes at least one of the following:
first indication information, where the first indication information is configured to indicate a target type of terminal to be woken up;
second indication information, where the second indication information is configured to indicate a target BWP to be woken up; or
third indication information, where the third indication information is configured to indicate a specified terminal to be woken up, and the specified terminal includes at least one of at least one group of terminals grouped based on a PO or at least one group of terminals grouped based on a PEI.

In some examples, the first indication information, the second indication information, and the third indication information may be all indicated by at least one bit in the first LP-WUS.

In some examples, the target type of terminal may include at least one of the first type of terminal or the second type of terminal. In some examples, the target type of terminal includes at least one of the following: a normal terminal, a Redcap terminal, or an eRedcap terminal. In some examples, the first indication information may be configured to indicate one or more target types of terminals to be woken up.

In some examples, the target BWP may include at least one of the first initial BWP or the second initial BWP. In some examples, the target BWP may further include any BWP other than at least one of the first initial BWP or the second initial BWP. In some examples, the second indication information may be configured to indicate one or more target BWPs to be woken up.

In some examples, the target BWP to be woken up refers to waking up the monitoring of paging on the target BWP. For example, after the terminal is woken up, the target BWP to be woken up is acquired, and the terminal may monitor a paging message, a PEI, or the like on the target BWP.

In some examples, the specified terminal may further include at least one group of terminals grouped according to a preset grouping rule.

In the embodiment of the present disclosure, in a case where the first LP-WUS includes the first indication information, the target type of terminal may be woken up. And/or, in a case where the first LP-WUS includes the second indication information, the terminal may monitor paging on the target BWP after being woken up, such that the probability of monitoring paging by the terminal is increased. And/or, in a case where the first LP-WUS includes the third indication information, the specified terminal may be woken up.

It is to be noted that, those skilled in the art may understand that the method provided by the embodiment of the present disclosure may be performed separately, or performed with some methods in the embodiment of the present disclosure or some methods in the related art.

A method for waking up below is performed by a terminal and is similar to the descriptions of the method for waking up performed by the network device above. As for technical details which are not disclosed in an embodiment of the method for waking up performed by the terminal below, please refer to the descriptions about the examples of the method for waking up performed by the network device above, which is not detailed in the present disclosure.

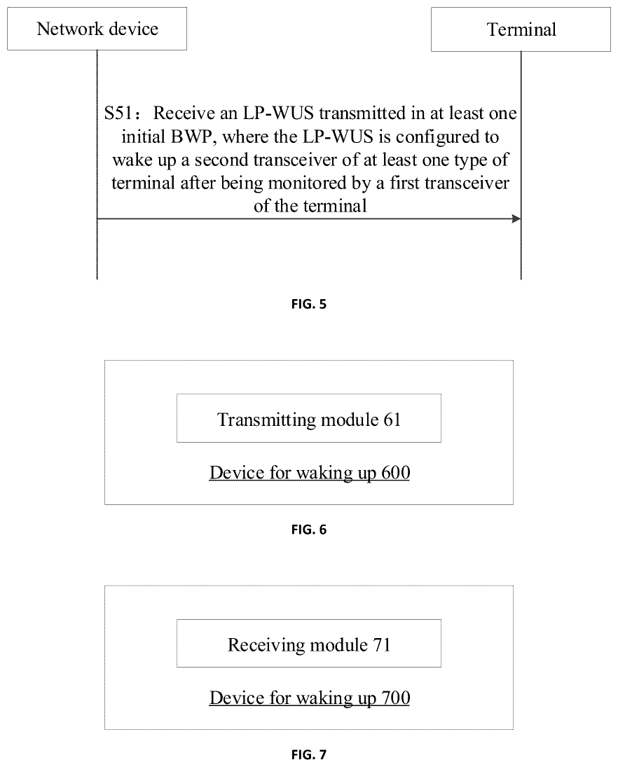

As shown in FIG. 5, an embodiment of the present disclosure provides a method for waking up, performed by a terminal, including the following step S51.

In step S51, an LP-WUS transmitted in at least one initial BWP is received, where the LP-WUS is configured to wake up a second transceiver of at least one type of terminal after being monitored by a first transceiver of the terminal.

In some embodiments of the present disclosure, the initial BWP may be the initial BWP in the above embodiment, the LP-WUS may be the LP-WUS in the above embodiment, the terminal may be the terminal in the above embodiment, and the first transceiver and the second transceiver may respectively be the first transceiver and the second transceiver in the above embodiment.

In some embodiments, receiving the LP-WUS transmitted in the at least one initial BWP includes: receiving the LP-WUS transmitted in at least one initial BWP by a network device.

In some embodiments, waking up the terminal may include: waking up the second transceiver of the terminal. For example, the terminal includes the first transceiver and the second transceiver. After the first transceiver is woken up, the terminal monitors the LP-WUS through the first transceiver, and in a case where the LP-WUS is monitored, the second transceiver is woken up.

In some examples, the terminal includes a first type of terminal and a second type of terminal.

In some examples, the first type of terminal may be a normal terminal or any terminal. For instance, the first type of terminal is an eMBB terminal. And/or, the second type of terminal may be at least one of a Redcap terminal or an eRedcap terminal.

In some examples, the first type of terminal has a higher power consumption than the second type of terminal.

In some examples, a limited range of at least one of time domain resources or frequency domain resources scheduled from the first type of terminal is larger than a limited range of at least one of time domain resources or frequency domain resources scheduled from the second type of terminal. Alternatively, a limited degree of at least one of time domain resources or frequency domain resources scheduled from the first type of terminal is higher than a limited degree of at least one of time domain resources or frequency domain resources scheduled from the second type of terminal.

In some examples, the power consumption of the first transceiver is less than that of the second transceiver. The power consumption of the first transceiver being less than that of the second transceiver may include: power consumed by receiving information and/or transmitting information by the first transceiver being less than power consumed by receiving information and/or transmitting information by the second transceiver.

In some examples, the structure of the first transceiver is simpler than that of the second transceiver. For example, the second transceiver may be a main radio of the terminal; and the first transceiver is an independent transceiver (low power wake-up receiver) introduced by the terminal. For example, the first transceiver is an auxiliary radio, and the second transceiver is the main radio.

In some embodiments, one initial BWP includes at least one of a first initial BWP or a second initial BWP.

In some examples, the first initial BWP may be an initial BWP configured by the network device. For example, the network device configures the first initial BWP through a system message. In some examples, the network device configures the first initial BWP through a master information block (MIB) or a system message block (SIB) X, where X is an integer greater than 0.

In some examples, the second initial BWP may also be an initial BWP configured by the network device. The second initial BWP may include at least one of a first control resource set (Coreset0) or a synchronization signal block (SSB).

In some examples, the first initial BWP is different from the second initial BWP.

In some embodiments, the initial BWP is a downlink initial BWP. In some examples, the first initial BWP is a first downlink initial BWP, and/or the second initial BWP is a second downlink initial BWP.

In some examples, the LP-WUS includes at least one of a first LP-WUS or a second LP-WUS. In some examples, the first LP-WUS is configured to wake up a first type of terminal, and/or the second LP-WUS is configured to wake up a second type of terminal.

For example, the above implementations may refer to the descriptions on the terminal, and will not be repeated in the present disclosure.

It is to be noted that, those skilled in the art may understand that the method provided by the embodiment of the present disclosure may be performed separately, or performed with some methods in the embodiment of the present disclosure or some methods in the related art.

In some embodiments, receiving the LP-WUS transmitted in the at least one initial BWP includes one of the following:
receiving different LP-WUSs transmitted in different initial BWPs, where the different LP-WUSs transmitted in the different initial BWPs are configured to wake up different types of terminals; or
receiving the LP-WUS transmitted in one initial BWP, where the LP-WUS is configured to wake up at least one type of terminal.

The embodiment of the present disclosure provides the method for waking up, performed by the terminal, including:
receiving different LP-WUSs transmitted in different initial BWPs, where the different LP-WUSs transmitted in the different initial BWPs are configured to wake up different types of terminals; or
receiving the LP-WUS transmitted in one initial BWP, where the LP-WUS is configured to wake up at least one type of terminal.

In some embodiments, receiving the different LP-WUSs transmitted in the different initial BWPs includes at least one of the following:
receiving first configuration information including the first LP-WUS transmitted in the first initial BWP, where the first LP-WUS transmitted in the first initial BWP is configured to wake up the first type of terminal; or
receiving second configuration information including the second LP-WUS transmitted in the second initial BWP, where the second LP-WUS transmitted in the second initial BWP is configured to wake up the second type of terminal.

The embodiment of the present disclosure provides the method for waking up, performed by the terminal, including:
receiving the first configuration information including the first LP-WUS transmitted in the first initial BWP, where the first LP-WUS transmitted in the first initial BWP is configured to wake up the first type of terminal; or
receiving the second configuration information including the second LP-WUS transmitted in the second initial BWP, where the second LP-WUS transmitted in the second initial BWP is configured to wake up the second type of terminal.

In some embodiments, the initial BWP includes at least one of a first control resource set (Coreset0) or an SSB.

In some examples, the first initial BWP includes at least one of a first control resource set (Coreset0) or an SSB.

In some examples, the second initial BWP includes at least one of a first control resource set (Coreset0) or an SSB.

For example, as for the first type of terminal, after monitoring the first initial BWP, the first type of terminal wakes up the second transceiver based on the first LP-WUS included in the first initial BWP.

For example, as for the second type of terminal, after monitoring the second initial BWP, the second type of terminal wakes up the second transceiver based on the second LP-WUS included in the second initial BWP.

In some embodiments of the present disclosure, the first configuration information and the second configuration information may be the first configuration information and the second configuration information in the above embodiment respectively.

In some examples, the first configuration information includes at least one of time domain information or frequency domain information of the monitored first LP-WUS. For example, the at least one of time domain information or frequency domain information is configured to indicate at least one of time domain resource or frequency domain resource for transmitting the first LP-WUS.

In some examples, the second configuration information includes time domain information of the monitored second LP-WUS. For example, the time domain information is configured to indicate the second LP-WUS. For example, the time domain information includes at least one of the following: a duty cycle or a configuration reference time point.

In some examples, the configuration reference time point includes at least one of the following: an offset value of a PO, or an offset value of a PEI. As the second configuration information includes the time domain information of the second LP-WUS, the second configuration information is applicable to being shared by a plurality of initial BWPs.

In some embodiments, the LP-WUS is configured to wake up one of the following:
all terminals monitoring the LP-WUS, or at least part of the terminals monitoring the LP-WUS; or
a specified terminal, where the specified terminal includes at least one of the following: at least one group of terminals grouped based on the PEI, or at least one group of terminals grouped based on the PO.

In some examples, the specified terminal may be a terminal grouped according to a preset grouping rule. The preset grouping rule may be any grouping rule. For example, the preset grouping rule may include a rule of grouping based on indexes or serial numbers of terminals, a rule of grouping based on operators to which terminals belong, or the like, which is not limited to the present disclosure.

In some examples, the LP-WUS is the first LP-WUS, and the first LP-WUS is configured to wake up one of the following: all first type of terminals monitoring the first LP-WUS, at least part of the first type of terminals monitoring the first LP-WUS, or a specified first type of terminal.

In some examples, the LP-WUS is the second LP-WUS, and the second LP-WUS is configured to wake up one of the following: all second type of terminals monitoring the second LP-WUS, at least part of the second type of terminals monitoring the second LP-WUS, or a specified second type of terminal.

For example, the above implementations may refer to the descriptions on the terminal, and will not be repeated in the present disclosure.

It is to be noted that, those skilled in the art may understand that the method provided by the embodiment of the present disclosure may be performed separately, or performed with some methods in the embodiment of the present disclosure or some methods in the related art.

In some embodiments, the LP-WUS includes the first LP-WUS. Receiving the LP-WUS transmitted in the one initial BWP includes: receiving the first configuration information including the first LP-WUS transmitted in the one initial BWP, where the first LP-WUS is configured to wake up a plurality of types of terminals.

An embodiment of the present disclosure provides a method for waking up, performed by a terminal, including: receiving first configuration information including a first LP-WUS transmitted in one initial BWP, where the first LP-WUS is configured to wake up a plurality of types of terminals.

In some embodiments, receiving the first configuration information including the first LP-WUS transmitted in the one initial BWP includes: receiving the first configuration information including the first LP-WUS transmitted in a first initial BWP, where the first LP-WUS transmitted in the first initial BWP is further configured to wake up a second type of terminal.

An embodiment of the present disclosure provides a method for waking up, performed by a terminal, including: receiving first configuration information including a first LP-WUS transmitted in a first initial BWP, where the first LP-WUS transmitted in the first initial BWP is further configured to wake up a second type of terminal.

For example, as for a first type of terminal, after monitoring the first initial BWP, the first type of terminal wakes up a second transceiver based on the first LP-WUS included in the first initial BWP.

For example, as for the second type of terminal, after monitoring a second initial BWP, the second type of terminal determines that the second initial BWP does not include a second LP-WUS, or the second type of terminal determines that the second initial BWP does not include at least one of Coreset0 or an SSB (i.e., the second type of terminal cannot determine that the second LP-WUS is not configured in the second initial BWP). Then the second type of terminal monitors the first initial BWP, and determines to wake up the second transceiver in a case of determining that the first initial BWP includes the first LP-WUS.

In some embodiments, the first LP-WUS includes at least one of the following:
first indication information, where the first indication information is configured to indicate a target type of terminal to be woken up;
second indication information, where the second indication information is configured to indicate a target BWP to be woken up; or
third indication information, where the third indication information is configured to indicate a specified terminal to be woken up, and the specified terminal includes at least one of at least one group of terminals grouped based on a PO or at least one group of terminals grouped based on a PEI.

In some embodiments of the present disclosure, the first indication information, the second indication information, and the third indication information may be the first indication information, the second indication information, and the third indication information in the above embodiment respectively. The target type of terminal, the target BWP, and the specified terminal may be the target type of terminal, the target BWP, and the specified terminal in the above embodiment respectively.

It is to be noted that, those skilled in the art may understand that the method provided by the embodiment of the present disclosure may be performed separately, or performed with some methods in the embodiment of the present disclosure or some methods in the related art.

In some examples, the specified terminal may further include at least one group of terminals grouped according to a preset grouping rule.

For example, the above implementations may refer to the descriptions on the terminal, and will not be repeated in the present disclosure.

It is to be noted that, those skilled in the art may understand that the method provided by the embodiment of the present disclosure may be performed separately, or performed with some methods in the embodiment of the present disclosure or some methods in the related art.

In order to further explain any embodiment of the present disclosure, a specific embodiment is provided below.

### Example I

An embodiment of the present disclosure relates to a method for waking up, including the following steps.

In some embodiments, a wakeup working mode is adopted when a terminal in a non-connected state uses an independent transceiver. The independent transceiver is configured to receive a low power wake-up signal, and at the moment, a main wireless receiver is woken up. In some examples, the independent transceiver is a first transceiver, and/or the main wireless receiver is a second transceiver.

In some embodiments, a network device transmits LP-WUS-related configuration (e.g., first configuration information) in different initial BWPs, which is configured to wake up different types of terminals.

As an embodiment: as for a normal terminal, the LP-WUS-related configuration (e.g., the first configuration information) is transmitted in a first downlink initial BWP, which is configured to wake up a first type of terminal (i.e., normal terminal). The first downlink initial BWP is a downlink initial BWP configured by the network device, namely an initial downlink BWP (initial DL BWP) configured by an MIB or SIB1.

As an embodiment: as for a Redcap terminal, in a case where a second downlink initial BWP specific to the Redcap terminal includes at least one of Coreset0 or an SSB, the LP-WUS-related configuration (e.g., second configuration information) may be transmitted in the second downlink initial BWP, which is configured to wake up a second type of terminal (i.e., Redcap terminal).

In some examples, transmitting the LP-WUS-related configurations in the initial BWP is on the premise that the downlink initial BWP includes at least one of the Coreset0 or the SSB.

In some examples, in a case where at least one of a search space for a paging message or a PEI is configured on the initial BWP and there is no LP-WUS-related configuration, the terminal follows a legacy paging mechanism, i.e., monitoring at least one of the paging message or the PEI.

In some examples, a target terminal that is woken up is a terminal monitoring the LP-WUS on the initial BWP, refers to all terminals, or refers to part of groups which are specified to be woken up (for example, a grouping method may be grouping based on a PEI or grouping based on a PO).

In some embodiments, a network device transmits LP-WUS-related configurations (e.g., first configuration information) in one initial BWP, which is configured to wake up a plurality of types of terminals.

As an embodiment: as for the second type of terminal (i.e., Redcap terminal), in a case where the second downlink initial BWP of the Redcap terminal does not include at least one of the Coreset0 or the SSB, the LP-WUS-related configuration cannot be transmitted in the second downlink initial BWP; and at the moment, the Redcap terminal needs to monitor an LP-WUS in the first downlink initial BWP, which is configured to wake up the second type of terminal (i.e., Redcap terminal). That is, the LP-WUS-related configuration transmitted in one initial BWP are configured to wake up the plurality of types of terminals.

In some examples, in a case where the network device transmits the LP-WUS in the one initial BWP to wake up the plurality of types of terminals,
the LP-WUS may carry a type of a target terminal to be woken up, for example, the target terminal is a normal terminal, a Redcap terminal, or an eRedcap terminal; and
the LP-WUS may carry a target BWP to be woken up, namely waking up a terminal which monitors paging on a certain BWP.

In some examples, the LP-WUS may be used in combination with grouped wakeup, for example, waking up terminals grouped based on a specific PO or a specific PEI among Redcap terminals.

In some embodiments, the LP-WUS-related configurations (e.g., the first configuration information) include at least one of time domain information or frequency domain information of the monitored LP-WUS.

In some embodiments, the LP-WUS-related configurations (e.g., the second configuration information) include time domain information of the monitored LP-WUS, such as at least one of a duty cycle, a PO offset, or other parameters. The second configuration information may be shared by a plurality of downlink initial BWPs.

For example, the above implementations may refer to the descriptions on the terminal and/or the network device, and will not be repeated in the present disclosure.

It is to be noted that, those skilled in the art may understand that the method provided by the embodiment of the present disclosure may be performed separately, or performed with some methods in the embodiment of the present disclosure or some methods in the related art.

### Example II

An embodiment of the present disclosure provides a method for waking up, performed by a communication device. The communication device includes a terminal and a network device. The method for waking up includes the following steps.

The network device transmits a low power wake-up signal (LP-WUS) to at least one terminal or at least one type of terminal in at least one initial BWP; and
a second transceiver of the terminal is woken up after the terminal monitors and receives the LP-WUS by using a first transceiver.

In some embodiments, the network device transmits first configuration information to a first type of terminal in a first initial BWP, where the first configuration information includes a first LP-WUS; and the first type of terminal wakes up a second transceiver of the first type of terminal based on the first LP-WUS. The first initial BWP includes at least one of Coreset0 or an SSB.

In some embodiments, the network device transmits second configuration information to a second type of terminal in a second initial BWP, where the second configuration information includes a second LP-WUS; and the second type of terminal wakes up a second transceiver of the second type of terminal based on the second LP-WUS. The second initial BWP includes at least one of the Coreset0 or the SSB.

In some embodiments, in a case where the initial BWP includes at least one of the Coreset0 or the SSB but the network device does not configure the LP-WUS on the initial BWP, the terminal may be enabled to perform paging according to a traditional paging mechanism on the initial BWP, and thus the terminal may be woken up.

In some embodiments, the network device transmits the first configuration information to the first type of terminal in the first initial BWP, where the first configuration information includes the first LP-WUS. In a case where the second type of terminal monitors that the second initial BWP does not include at least one of the Coreset0 or the SSB, the second type of terminal monitors the first initial BWP; and the second type of terminal wakes up the second transceiver of the second type of terminal after monitoring the first LP-WUS carried on the first initial BWP. The first initial BWP includes at least one of the Coreset0 or the SSB.

For example, the above implementations may refer to at least one of the description on the terminal or the description on the network device, and will not be repeated in the present disclosure.

It is to be noted that, those skilled in the art may understand that the method provided by the embodiment of the present disclosure may be performed separately, or performed with some methods in the embodiment of the present disclosure or some methods in the related art.

As shown in FIG. 6, an embodiment of the present disclosure provides a device for waking up 600, including:
a transmitting module 61 configured to transmit an LP-WUS in at least one initial BWP, where the LP-WUS is configured to wake up a second transceiver of at least one type of terminal after being monitored by a first transceiver of the terminal.

The device for waking up 600 provided by the embodiment of the present disclosure may be a network device.

An embodiment of the present disclosure provides a device for waking up 600, including: a transmitting module 61 configured to transmit different LP-WUSs in different initial BWPs, where the different LP-WUSs transmitted in the different initial BWPs are configured to wake up different types of terminals.

An embodiment of the present disclosure provides a device for waking up 600, including: a transmitting module 61 configured to transmit the LP-WUS in one initial BWP, where the LP-WUS is configured to wake up at least one type of terminal.

In some embodiments, the initial BWP includes at least one of a first initial BWP or a second initial BWP. The LP-WUS includes at least one of a first LP-WUS or a second LP-WUS.

An embodiment of the present disclosure provides a device for waking up 600, including: a transmitting module 61 configured to perform at least one of the following:
transmitting first configuration information including the first LP-WUS in the first initial BWP, where the first LP-WUS transmitted in the first initial BWP is configured to wake up a first type of terminal; or
transmitting second configuration information including the second LP-WUS in the second initial BWP, where the second LP-WUS transmitted in the second initial BWP is configured to wake up a second type of terminal.

In some embodiments, the initial BWP includes at least one of a first control resource set (Coreset0) or an SSB. In some examples, the first initial BWP includes at least one of the first control resource set (Coreset0) or the SSB. In some examples, the second initial BWP includes at least one of the first control resource set (Coreset0) or the SSB.

In some embodiments, the LP-WUS is configured to wake up one of the following:
all terminals monitoring the LP-WUS, or at least part of the terminals monitoring the LP-WUS; or
a specified terminal, where the specified terminal includes at least one of the following: at least one group of terminals grouped based on a PEI, or at least one group of terminals grouped based on a PO.

An embodiment of the present disclosure provides a device for waking up 600, including: a transmitting module 61 configured to transmit first configuration information including a first LP-WUS in one initial BWP, where the first LP-WUS is configured to wake up a plurality of types of terminals.

An embodiment of the present disclosure provides a device for waking up 600, including: a transmitting module 61 configured to transmit, based on a fact that a second initial BWP does not include at least one of a first control resource set (Coreset0) or an SSB, the first configuration information including a first LP-WUS in the first initial BWP, where the first LP-WUS transmitted in the first initial BWP is further configured to wake up a second type of terminal.

In some embodiments, the first LP-WUS includes at least one of the following:
first indication information, where the first indication information is configured to indicate a target type of terminal to be woken up;
second indication information, where the second indication information is configured to indicate a target BWP to be woken up; or
third indication information, where the third indication information is configured to indicate a specified terminal to be woken up, where the specified terminal includes at least one of at least one group of terminals grouped based on a PO or at least one group of terminals grouped based on a PEI.

In some embodiments, the first configuration information includes at least one of time domain information or frequency domain information of the monitored first LP-WUS.

In some embodiments, the second configuration information includes time domain information for monitoring the second LP-WUS, where the time domain information includes at least one of the following: a duty cycle or a configuration reference time point. In some examples, the configuration reference time point includes at least one of the following: an offset value of a PO, or an offset value of a PEI.

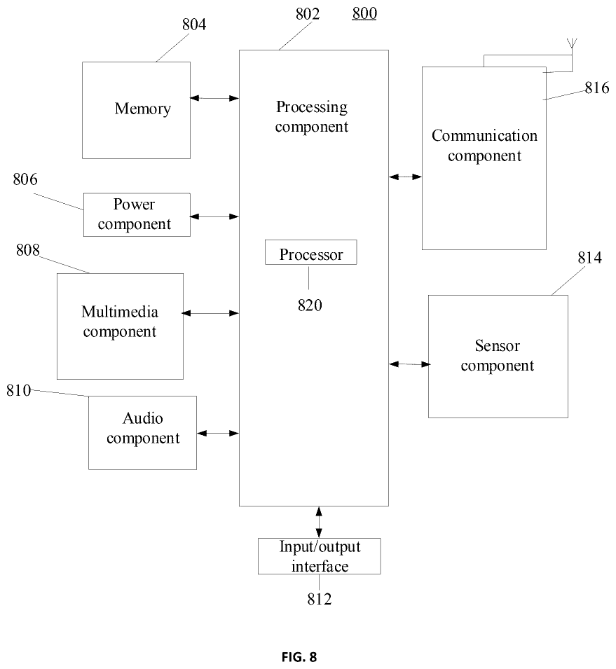

As shown in FIG. 7, an embodiment of the present disclosure provides a device for waking up 700, including:
a receiving module 71 configured to receive an LP-WUS transmitted in at least one initial BWP, where the LP-WUS is configured to wake up a second transceiver of at least one type of terminal after being monitored by a first transceiver of the terminal.

The device for waking up 700 provided by the embodiment of the present disclosure may be a terminal.

An embodiment of the present disclosure provides a device for waking up 700, including: a receiving module 71 configured to perform one of the following:
receiving different LP-WUSs transmitted in different initial BWPs, where the different LP-WUSs transmitted in the different initial BWPs are configured to wake up different types of terminals; or
receiving the LP-WUS transmitted in one initial BWP, where the LP-WUS is configured to wake up at least one type of terminal.

An embodiment of the present disclosure provides a device for waking up 700, including: a receiving module 71 configured to perform at least one of the following:
receiving first configuration information including the first LP-WUS transmitted in a first initial BWP, where the first LP-WUS transmitted in the first initial BWP is configured to wake up a first type of terminal; or
receiving second configuration information including the second LP-WUS transmitted in a second initial BWP, where the second LP-WUS transmitted in the second initial BWP is configured to wake up a second type of terminal.

In some embodiments, the initial BWP includes at least one of a first control resource set (Coreset0) or an SSB. In some examples, the first initial BWP includes at least one of the first control resource set (Coreset0) or the SSB. In some examples, the second initial BWP includes at least one of the first control resource set (Coreset0) or the SSB.

In some embodiments, the LP-WUS is configured to wake up one of the following:
all terminals monitoring the LP-WUS, or at least part of the terminals monitoring the LP-WUS; or
a specified terminal, where the specified terminal includes at least one of the following: at least one group of terminals grouped based on a PEI, or at least one group of terminals grouped based on a PO.

An embodiment of the present disclosure provides a device for waking up 700, including: a receiving module 71 configured to receive first configuration information including the first LP-WUS transmitted in one initial BWP, where the first LP-WUS is configured to wake up a plurality of types of terminals.

An embodiment of the present disclosure provides a device for waking up 700, including: a receiving module 71 configured to receive first configuration information including a first LP-WUS transmitted in a first initial BWP, where the first LP-WUS transmitted in the first initial BWP is further configured to wake up a second type of terminal.

In some embodiments, the first LP-WUS includes at least one of the following:
first indication information, where the first indication information is configured to indicate a target type of terminal to be woken up;
second indication information, where the second indication information is configured to indicate a target BWP to be woken up; or
third indication information, where the third indication information is configured to indicate a specified terminal to be woken up, where the specified terminal includes at least one of at least one group of terminals grouped based on a PO or at least one group of terminals grouped based on a PEI.

In some embodiments, the first configuration information includes at least one of time domain information or frequency domain information of the monitored first LP-WUS.

In some embodiments, the second configuration information includes time domain information of a monitored second LP-WUS, where the time domain information includes at least one of the following: a duty cycle or a configuration reference time point. In some examples, the configuration reference time point includes at least one of the following: an offset value of a PO, or an offset value of a PEI.

It is to be noted that, those skilled in the art may understand that the device provided by the embodiment of the present disclosure may be performed separately, or performed with some devices in the embodiment of the present disclosure or some devices in the related art.

As for the device in the above embodiments, the specific manner in which each module performs operations has been described in detail in the embodiments about the method, which will not be described in detail in the present disclosure.

An embodiment of the present disclosure provides a communication device, including a processor, a transceiver, a memory, and an executable program stored on the memory and executable by the processor, where the executable program, when implements by the processor, implements the method for waking up provided above.

In some embodiments, the processor may include various types of storage media. The storage media are non-transitory computer storage media, and may continue to memorize information stored after the communication device is powered down.

In some embodiments, the communication device includes: a terminal or a network device.

The processor may be connected with the memory via a bus and the like, and is configured to read an executable program stored on the memory, such as at least one of the methods shown in FIG. 2 to FIG. 5.

An embodiment of the present disclosure provides a computer storage medium which stores an executable program, where the executable program, when executed by a processor, may implement the method for waking up provided above. For example, the method is at least one of the methods as shown in FIG. 2 to FIG. 5.

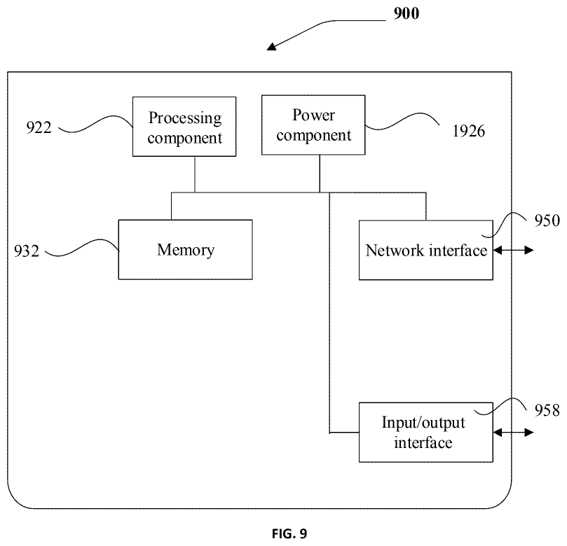

FIG. 8 is a block diagram of a terminal 800 according to an example. For example, the terminal 800 may be a mobile phone, a computer, digital broadcasting user equipment, a messaging device, a game console, a tablet device, a medical device, a fitness device, and a personal digital assistant, etc.

Referring to FIG. 8, the terminal 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls the overall operation of the terminal 800, such as operations associated with display, telephone call, data communication, camera operations, and recording operations. The processing component 802 may include one or more processors 820 to execute instructions to generate all or part of the steps of the above method. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations at the terminal 800. Instances of these data include instructions for any application or method operating on the terminal 800, contact data, phonebook data, messages, pictures, videos, etc. The memory 804 may be implemented by any type of volatile or nonvolatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optic disk.

The power component 806 provides power for various components of the terminal 800. The power component 806 may include a power management system, one or more power sources, and other components associated with generating, managing and distributing power for the terminal 800.

The multimedia component 808 includes a screen providing an output interface between the terminal 800 and a user. In some embodiments, the screen may include a liquid crystal display (LCD) and a touch panel (TP). In a case where the screen includes the touch panel, the screen may be implemented as a touch screen to receive an input signal from the user. The touch panel includes one or more touch sensors to sense touch, sliding, and gestures on the touch panel. The touch sensor may not only sense the boundary of the touch or sliding operation, but also detect the duration and pressure related to the touch or sliding operation. In some embodiments, the multimedia component 808 includes at least one of a front camera or a rear camera. When the terminal 800 is in an operation mode, such as a shooting mode or a video mode, at least one of the front camera or the rear camera may receive external multimedia data. Each front camera and rear camera may be a fixed optical lens system or have a focal length and optical zoom capability.

The audio component 810 is configured to output and/or input audio signals. For example, the audio component 810 includes a microphone (MIC) configured to receive an external audio signal when the terminal 800 is in the operation mode, such as a call mode, a recording mode, and a speech recognition mode. The received audio signal may further be stored in the memory 804 or transmitted via the communication component 816. In some embodiments, the audio component 810 also includes a speaker for outputting an audio signal.

The I/O interface 812 provides an interface between the processing component 802 and a peripheral interface module which may be a keyboard, a click wheel, a button, etc. These buttons may include but are not limited to: a home button, volume buttons, a start button, and a lock button.

The sensor component 814 includes one or more sensors for providing state evaluation of various aspects for the terminal 800. For example, the sensor component 814 may detect an on/off state of the terminal 800 and the relative positioning of the components, for example, the components are a display and a keypad of the terminal 800. The sensor component 814 may also detect the change of the position of the terminal 800 or one component of the terminal 800, the presence or absence of user contact with the terminal 800, the azimuth or acceleration/deceleration of the terminal 800, and temperature change of the terminal 800. The sensor component 814 may include a proximity sensor configured to detect the presence of nearby objects without any physical contact. The sensor component 814 may further include an optical sensor, such as a CMOS or CCD image sensor, for use in imaging applications. In some embodiments, the sensor component 814 may further include an acceleration sensor, a gyroscope sensor, a magnetic sensor, a pressure sensor, or a temperature sensor.

The communication component 816 is configured to facilitate wired or wireless communication between the terminal 800 and other devices. The terminal 800 may access a wireless network based on a communication standard, such as WiFi, 2G or 3G, or their combination. In an example, the communication component 816 receives a broadcast signal or broadcast-related information from an external broadcast management system via a broadcast channel. In an example, the communication component 816 further includes a near field communication (NFC) module to facilitate short-range communication. For instance, the NFC module may be implemented based on a radio frequency identification (RFID) technology, an infrared data association (IrDA) technology, an ultra-wideband (UWB) technology, a Bluetooth (BT) technology, and other technologies.

In an example, the terminal 800 may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic elements for performing the above method.

In an example, a non-transitory computer-readable storage medium including instructions, such as the memory 804 including instructions which may be executed by the processor 820 of the terminal 800 to generate the above method, is also provided. For instance, the non-transitory computer-readable storage medium may be a ROM, a random access memory (RAM), a CD-ROM, a magnetic tape, a floppy disk, an optical data storage device, etc.

As shown in FIG. 9, an embodiment of the present disclosure shows a structure of a communication device. For example, the communication device 900 may be provided as a network device. The communication device may be various network elements such as at least one of the aforementioned access network elements or the aforementioned network functions. The communication device may be the terminal or the network device in the above embodiments.

Referring to FIG. 9, the communication device 900 includes a processing component 922, which further includes one or more processors, and a memory resource represented by a memory 932 for storing instructions, such as applications, that may be executed by the processing component 922. The applications stored in the memory 932 may include one or more modules each corresponding to a set of instructions. In addition, the processing component 922 is configured to execute instructions to implement any method applied to an access device.

The communication device 900 may further include a power component 1926 configured to perform power management of the communication device 900, a wired or wireless network interface 950 configured to connect the communication device 900 to the network, and an input/output (I/O) interface 958. The communication device 900 may operate an operating system stored in the memory 932, such as Windows Server™, Mac OS X™, Unix™, Linux™, FreeBSD™, or the like.

The technical solution provided by the embodiments of the present disclosure may include the following beneficial effects.

In the embodiments of the present disclosure, the network device transmits the LP-WUS in the at least one initial BWP, where the LP-WUS is configured to wake up the second transceiver of the at least one type of terminal after being monitored by the first transceiver of the terminal. Thus, the second transceiver with relatively high power consumption is woken up only after the first transceiver with relatively low power consumption monitors the LP-WUS, so that the power consumption of the terminal may be lowered. Further, one or more types of terminals may be woken up by transmitting the LP-WUS in the at least one initial BWP, so that a specific manner of waking up the terminal is provided.

As used herein, the term “processor” may refer to one processor that performs the defined functions or a plurality of processors that collectively perform defined functions, such that the execution of the individual defined functions may be divided amongst such processors.

Where there is no contradiction, each step in a certain implementation or embodiment may be implemented as an independent embodiment. Moreover, the steps may be combined arbitrarily with one another. For example, a solution obtained by removing some steps from a certain implementation or embodiment may also be implemented as an independent embodiment; in addition, the order of the steps in a certain implementation or embodiment may be swapped arbitrarily. Furthermore, optional manners or optional cases in a certain implementation or embodiment may be combined arbitrarily. Besides, various implementations or embodiments may be combined arbitrarily with one another. For instance, some or all of the steps from different implementations or embodiments may be combined arbitrarily, and a certain implementation or embodiment may be combined arbitrarily with optional manners or optional cases of other implementations or embodiments.

Other implementation solutions of the present disclosure will be apparent to those skilled in the art from consideration of the specification and practice of the present disclosure. The present disclosure is intended to cover any variations, uses, or adaptations of the present disclosure following the general principles of the present disclosure and including such departures from the present disclosure as come within known or customary practice in the art. It is intended that the specification and embodiments be considered as illustrative merely, with a true scope and spirit of the present disclosure being indicated by the following claims.

It will be appreciated that the present disclosure is not limited to the exact construction that has been described above and illustrated in the accompanying drawings, and that various modifications and changes may be made without departing from its scope. The scope of the present disclosure is merely limited by the appended claims.

1. A method for waking up, performed by a network device, the method comprising:
transmitting a low power wake-up signal (LP-WUS) in at least one initial bandwidth part (BWP), wherein the LP-WUS is configured to wake up a second transceiver of at least one type of terminal after being monitored by a first transceiver of the terminal.

2. The method according to claim 1, wherein transmitting the low power wake-up signal (LP-WUS) in the at least one initial bandwidth part (BWP) comprises one of the following:
transmitting different LP-WUSs in different initial BWPs, wherein the different LP-WUSs transmitted in the different initial BWPs are configured to wake up different types of terminals; or
transmitting the LP-WUS in one initial BWP, wherein the LP-WUS is configured to wake up the at least one type of terminal.

3. The method according to claim 2, wherein the at least one initial BWP comprises at least one of a first initial BWP or a second initial BWP; the LP-WUS comprises at least one of a first LP-WUS or a second LP-WUS; and transmitting the different LP-WUSs in the different initial BWPs comprises at least one of the following:
transmitting first configuration information comprising the first LP-WUS in the first initial BWP, wherein the first LP-WUS transmitted in the first initial BWP is configured to wake up a first type of terminal; or
transmitting second configuration information comprising the second LP-WUS in the second initial BWP, wherein the second LP-WUS transmitted in the second initial BWP is configured to wake up a second type of terminal.

4. The method according to claim 3, wherein
the at least one initial BWP comprises at least one of a first control resource set (Coreset0) or a synchronization signal block (SSB).

5. The method according to claim 1, wherein the LP-WUS is configured to wake up one of the following:
all terminals monitoring the LP-WUS, or at least part of the terminals monitoring the LP-WUS; or
a specified terminal, wherein the specified terminal comprises at least one of the following: at least one group of terminals grouped based on a paging early indication (PEI), or at least one group of terminals grouped based on a paging occasion (PO).

6. The method according to claim 2, wherein the LP-WUS comprises a first LP-WUS; and transmitting the LP-WUS in the one initial BWP comprises:
transmitting first configuration information comprising the first LP-WUS in the one initial BWP, wherein the first LP-WUS is configured to wake up a plurality of types of terminals.

7. The method according to claim 6, wherein the at least one initial BWP comprises at least one of a first initial BWP or a second initial BWP; and transmitting the first configuration information comprising the first LP-WUS in the one initial BWP comprises:
transmitting, based on a fact that the second initial BWP does not comprise at least one of a first control resource set (Coreset0) or a synchronization signal block (SSB), the first configuration information comprising the first LP-WUS in the first initial BWP, wherein the first LP-WUS transmitted in the first initial BWP is further configured to wake up a second type of terminal.

8. The method according to claim 6, wherein the first LP-WUS comprises at least one of the following:
first indication information, wherein the first indication information is configured to indicate a target type of terminal to be woken up;
second indication information, wherein the second indication information is configured to indicate a target BWP to be woken up; or
third indication information, wherein the third indication information is configured to indicate a specified terminal to be woken up, and the specified terminal comprises at least one of at least one group of terminals grouped based on a paging occasion (PO) or at least one group of terminals grouped based on a paging early indication (PEI).

9. The method according to claim 3, wherein the first configuration information comprises at least one of time domain information or frequency domain information for monitoring the first LP-WUS;
wherein the second configuration information comprises time domain information for monitoring the second LP-WUS, wherein the time domain information comprises at least one of the following: a duty cycle or a configuration reference time point.

10. (canceled)

11. A method for waking up, performed by a terminal, the method comprising:
receiving a low power wake-up signal (LP-WUS) transmitted in at least one initial bandwidth part (BWP), wherein the LP-WUS is configured to wake up a second transceiver of at least one type of terminal after being monitored by a first transceiver of the terminal.

12. The method according to claim 11, wherein receiving the low power wake-up signal (LP-WUS) transmitted in the at least one initial bandwidth part (BWP) comprises one of the following:
receiving different LP-WUSs transmitted in different initial BWPs, wherein the different LP-WUSs transmitted in the different initial BWPs are configured to wake up different types of terminals; or
receiving the LP-WUS transmitted in one initial BWP, wherein the LP-WUS is configured to wake up the at least one type of terminal.

13. The method according to claim 12, wherein the at least one initial BWP comprises at least one of a first initial BWP or a second initial BWP; the LP-WUS comprises at least one of a first LP-WUS or a second LP-WUS; and receiving the different LP-WUSs transmitted in the different initial BWPs comprises at least one of the following:
receiving first configuration information comprising the first LP-WUS transmitted in the first initial BWP, wherein the first LP-WUS transmitted in the first initial BWP is configured to wake up a first type of terminal; or
receiving second configuration information comprising the second LP-WUS transmitted in the second initial BWP, wherein the second LP-WUS transmitted in the second initial BWP is configured to wake up a second type of terminal.

14. The method according to claim 13, wherein
the at least one initial BWP comprises at least one of a first control resource set (Coreset0) or a synchronization signal block (SSB).

15. The method according to claim 12, wherein the LP-WUS is configured to wake up one of the following:
all terminals monitoring the LP-WUS, or at least part of the terminals monitoring the LP-WUS; or
a specified terminal, wherein the specified terminal comprises at least one of the following: at least one group of terminals grouped based on a paging early indication (PEI), or at least one group of terminals grouped based on a paging occasion (PO).

16. The method according to claim 12, wherein the LP-WUS comprises a first LP-WUS; and receiving the LP-WUS transmitted in the one initial BWP comprises:
receiving first configuration information comprising the first LP-WUS transmitted in the one initial BWP, wherein the first LP-WUS is configured to wake up a plurality of types of terminals.

17. The method according to claim 16, wherein the at least one initial BWP comprises at least one of a first initial BWP or a second initial BWP, and receiving the first configuration information comprising the first LP-WUS transmitted in the one initial BWP comprises:
receiving the first configuration information comprising the first LP-WUS transmitted in the first initial BWP, wherein the first LP-WUS transmitted in the first initial BWP is further configured to wake up a second type of terminal.

18. The method according to claim 16, wherein the first LP-WUS comprises at least one of the following:
first indication information, wherein the first indication information is configured to indicate a target type of terminal to be woken up;
second indication information, wherein the second indication information is configured to indicate a target BWP to be woken up; or
third indication information, wherein the third indication information is configured to indicate a specified terminal to be woken up, and the specified terminal comprises at least one of at least one group of terminals grouped based on a paging occasion (PO) or at least one group of terminals grouped based on a paging early indication (PEI).

19. The method according to claim 13, wherein the first configuration information comprises at least one of time domain information or frequency domain information for monitoring the first LP-WUS;
wherein the second configuration information comprises time domain information for monitoring the second LP-WUS, wherein the time domain information comprises at least one of the following: a duty cycle or a configuration reference time point.

20-22. (canceled)

23. A network device, comprising: one or more processors, a transceiver, a memory, and an executable program stored on the memory and executable by the one or more processors, wherein the executable program, when executed by the one or more processors, causes the network device to:
transmit a low power wake-up signal (LP-WUS) in at least one initial bandwidth part (BWP), wherein the LP-WUS is configured to wake up a second transceiver of at least one type of terminal after being monitored by a first transceiver of the terminal.

24. (canceled)

25. A terminal, comprising: one or more processors, a transceiver, a memory, and an executable program stored on the memory and executable by the one or more processors, wherein the executable program, when executed by the one or more processors, causes the terminal to perform the method for waking up according to claim 11.
